(19) United States
(12) Patent Application Publication
(10) Pub. No.: US 2026/0083631 A1
(43) Pub. Date: Mar. 26, 2026

(54) MASSAGER CAPABLE OF TELESCOPIC AND OSCILLATING MASSAGE

(71) Applicant: Dongguan Mengma Electronic Technology Co., Ltd., Dongguan City (CN)

(72) Inventor: Dongtao Zhou, Dongguan City (CN)

(21) Appl. No.: 19/409,296

(22) Filed: Dec. 4, 2025

(30) Foreign Application Priority Data
Oct. 20, 2025 (CN) 202522212737.6

(51) Int. Cl. A61H 23/02

(52) U.S. Cl. CPC A61H 23/0254; A61H 2201/0165; A61H 2201/169

(57) ABSTRACT

A massager capable of telescopic and oscillating massage, including: a massage rod; a massage head located at an outer end of the massage rod; a first elastic layer wrapped around the massage rod and the massage head; a power device; a reciprocating telescopic assembly; and an oscillating connecting member. A first connecting portion and a second connecting portion are provided at two ends of the oscillating connecting member, respectively. A rotation axis k1 of an output portion and a rotation axis k2 of the second connecting portion are arranged non-collinearly. The massager is configured to perform telescopic and oscillating massage simultaneously.

### TECHNICAL FIELD

The present disclosure belongs to the field of massagers, and in particular, relates to a massager capable of telescopic and oscillating massage.

### BACKGROUND

A massager is configured to massage human acupuncture points to achieve health maintenance and care effects, with common massage parts including palms, soles, prostate, and other body parts.

A reciprocating telescopic massager employs an electric drive structure to drive the massage head to perform reciprocating telescopic movement, enabling the top end of the massage head to repeatedly impact the massage part to provide a massage effect, or the peripheral wall of the massage head to repeatedly rub the massage part to provide a massage effect.

However, the massage effect generated by rubbing and massaging the massage part simply through the peripheral wall of the massage head is poor, and it is difficult to efficiently massage and relax the massage part.

### SUMMARY

In view of the shortcomings existing in the related art, an object of the present disclosure is to provide a massager capable of telescopic and oscillating massage, which improves the massage effect through simultaneous telescopic and oscillating movement of a massage head.

To achieve the foregoing object, the present disclosure provides the following technical solution.

A massager capable of telescopic and oscillating massage is provided, including: a massage rod; a massage head located at an outer end of the massage rod; and a first elastic layer wrapped around the massage rod and the massage head to connect the massage rod and the massage head to form the massager. The massage rod includes: a power device provided within the massage rod; a reciprocating telescopic assembly provided within the massage rod and coupled to the massage rod, where one end of the reciprocating telescopic assembly is coupled to the power device, and the other end of the reciprocating telescopic assembly is provided with an output portion; and the reciprocating telescopic assembly is configured to be driven by the power device to perform reciprocating telescopic movement and rotation within the massage rod; and an oscillating connecting member, where a first connecting portion and a second connecting portion are provided at two ends of the oscillating connecting member, respectively; the first connecting portion is fixedly connected to the output portion, and the second connecting portion is rotatably assembled with the massage head, where a rotation axis of the output portion relative to the massage rod is k1, a rotation axis of the second connecting portion relative to the massage head is k2, and k1 and k2 are arranged non-collinearly; the power device drives the massage head to simultaneously perform reciprocating telescopic displacement along a lengthwise direction of the massage rod and rotational displacement about the axis k1, enabling the massager to perform telescopic and oscillating massage.

Through the foregoing technical solution, the operation of the power device causes the output portion to perform reciprocating telescopic movement along the forward-backward direction while rotating circumferentially, thereby enabling the oscillating connecting member to perform reciprocating telescopic movement along the forward-backward direction to drive the massage head to perform forward-backward telescopic movement. Due to the non-collinear arrangement of k1 and k2 and the rotation of the oscillating connecting member with the output portion, the second connecting portion rotates eccentrically relative to the first connecting portion continuously. In addition, since the massage head and the second connecting portion are rotatably mated, the massage head may perform continuous eccentric oscillation while performing reciprocating telescopic movement, so that the massage head may generate forward-backward telescopic movement and large-amplitude circumferential oscillation, thereby delivering stronger impact massage to the massage part around the outer periphery of the massage head, resulting in better and more efficient massage for improved relaxation.

### BRIEF DESCRIPTION OF THE DRAWINGS

FIG. 1 is an assembly diagram of embodiment 1 of the present disclosure;

FIG. 2 is an exploded diagram of embodiment 1 of the present disclosure;

FIG. 3 is a cross-sectional view of embodiment 1 of the present disclosure;

FIG. 4 is an exploded diagram of a partial structure in embodiment 1 of the present disclosure;

FIG. 5 is an exploded diagram of a partial structure in embodiment 1 of the present disclosure;

FIG. 6 is a cross-sectional view of a partial structure in embodiment 1 of the present disclosure;

FIG. 7 is an exploded diagram of a partial structure in embodiment 1 of the present disclosure;

FIG. 8 is an exploded diagram of a partial structure in embodiment 1 of the present disclosure;

FIG. 9 is an assembly diagram of embodiment 2 of the present disclosure;

FIG. 10 is an exploded diagram of embodiment 2 of the present disclosure;

FIG. 11 is a cross-sectional view of embodiment 2 of the present disclosure;

FIG. 12 is a partial enlarged view of FIG. 11;

FIG. 13 is an enlarged view of A in FIG. 11; and

FIG. 14 is an exploded diagram of a massage base in embodiment 2 of the present disclosure.

Description of reference numerals:

1-massage rod;

11-first installation cavity; 12-connecting protrusion;

121-snap slot; 122-wire channel;

2-massage head;

21-second installation cavity; 22-oscillating insertion hole; 23-first threading opening;

3-first elastic layer;

31-first encapsulation portion; 32-second encapsulation portion; 33-corrugated encapsulation portion; 34-connecting structure; 35-first assembly opening;

351-first cover; 352-first silicone pressing portion;

341-connecting perforation;

41-power device; 42-first vibration motor; 43-second vibration motor;

411-drive motor; 412-speed reduction device;

5-reciprocating telescopic assembly;

50-reciprocating telescopic shell; 51-power rotating shaft; 52-telescopic rotating shaft; 53-linkage member; 54-main housing; 55-end side cover;

511-mating insertion section; 521-mating insertion slot; 522-circular track; 523-output portion; 531-installation column portion; 532-crescent-shaped sliding portion; 541-telescopic channel; 542-first clamping half-slot; 552-second clamping half-slot;

6-oscillating connecting member;

61-first connecting portion; 62-second connecting portion;

71-circuit board; 72-power supply battery; 73-control button; 74-charging contact;

8-massage base;

81-third installation cavity; 82-third threading opening;

9-second elastic layer;

91-third encapsulation portion; 92-extension section; 93-wearing portion; and

911-second assembly opening; 912-second cover; 913-second silicone pressing portion; 921-wire perforation; 922-snap ring; and 931-wearing perforation.

### DESCRIPTION OF THE EMBODIMENTS

### Embodiment 1:

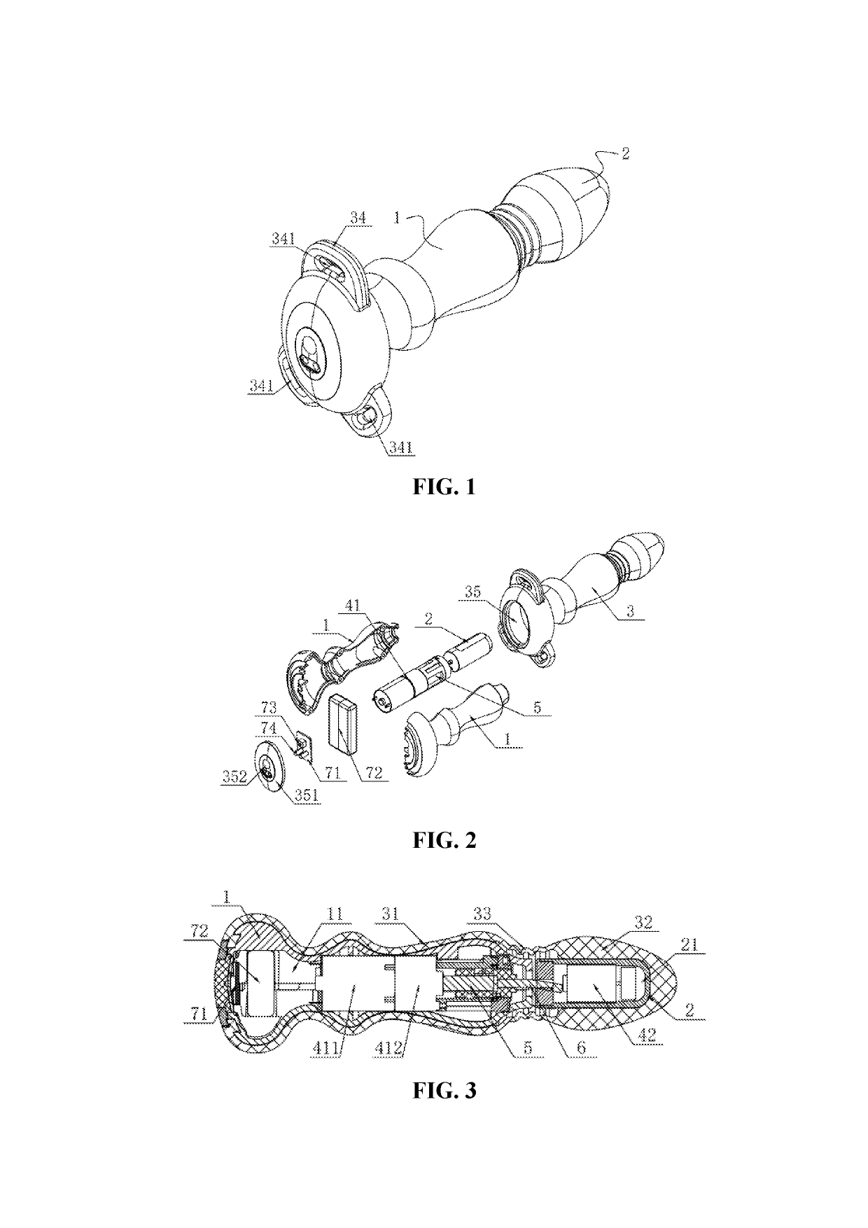

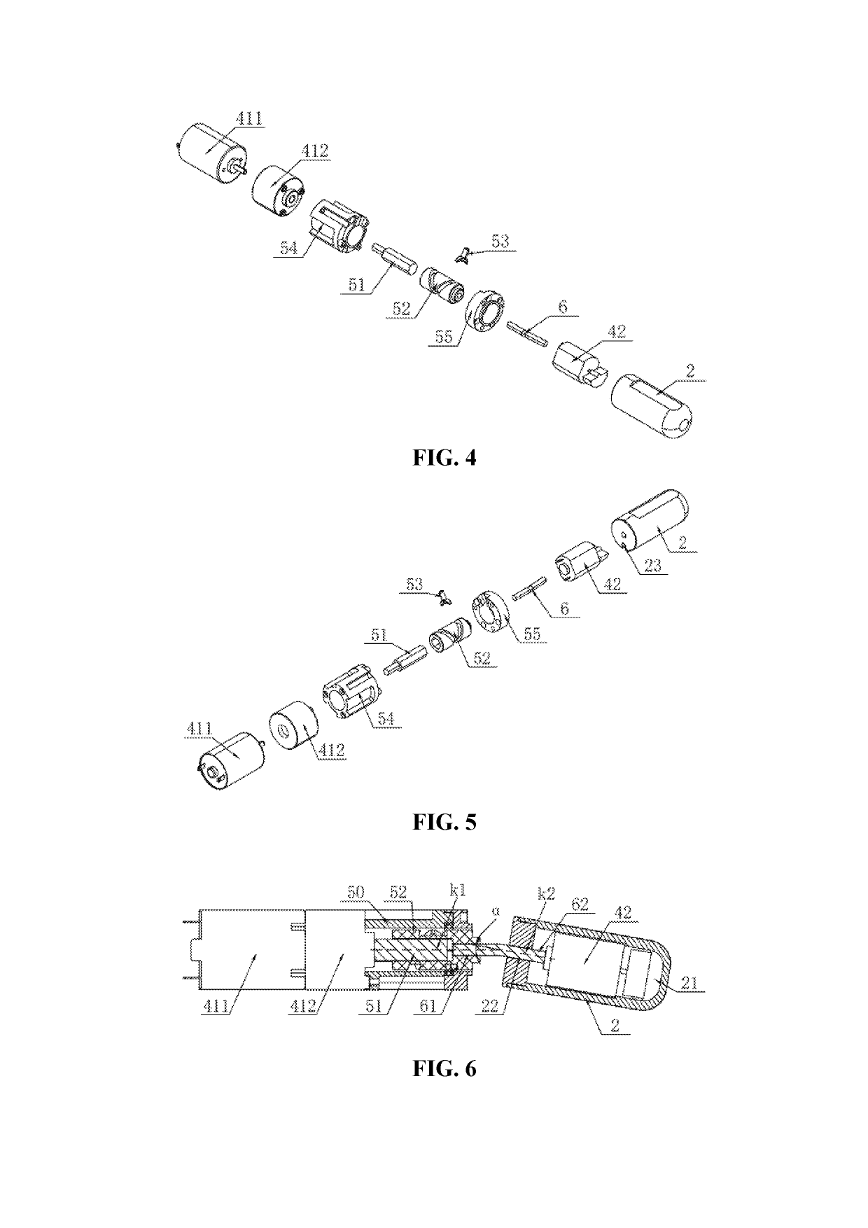

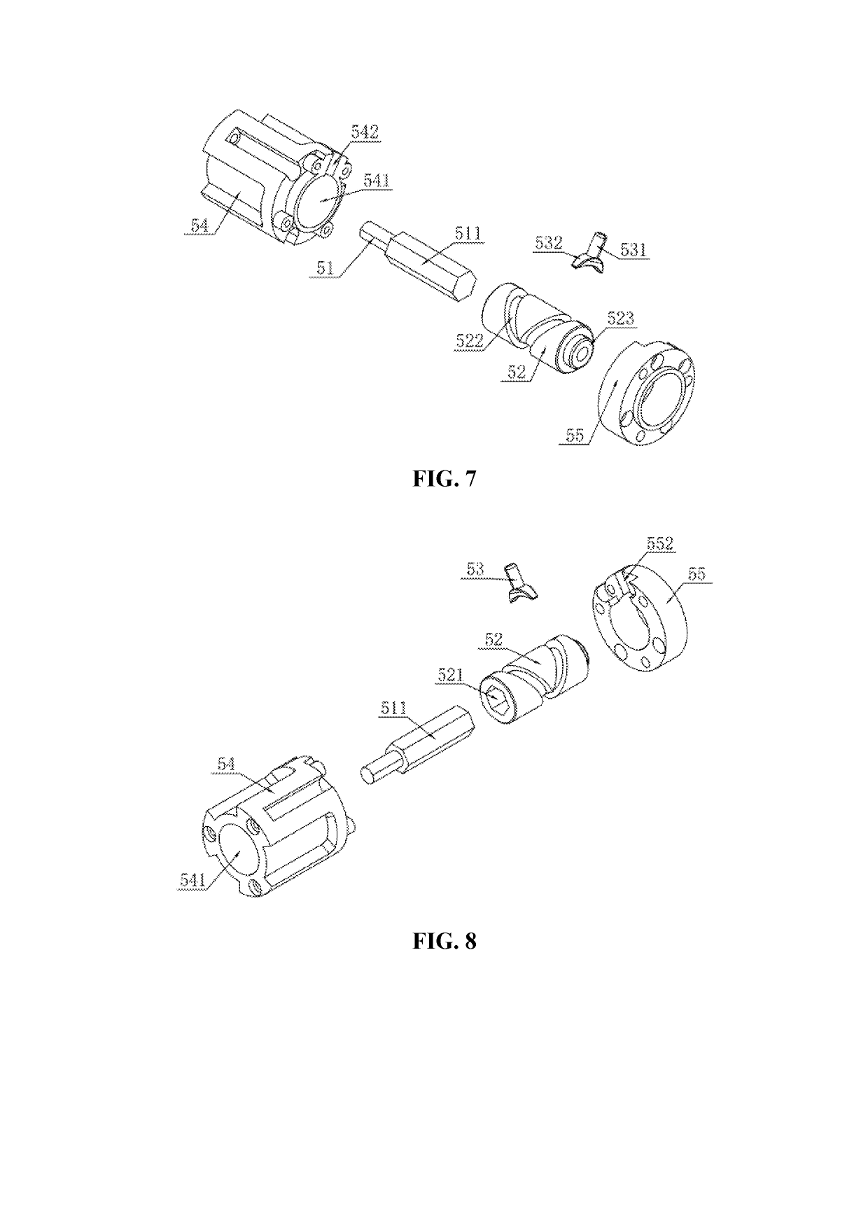

As shown in FIGS. 1 to 8, the present disclosure provides a massager capable of telescopic and oscillating massage, including: a massage rod 1, where a lengthwise direction of the massage rod 1 is a forward-backward direction, and a first installation cavity 11 is arranged inside the massage rod 1; a massage head 2, where the massage head 2 is located at a rear outer end of the massage rod 1, and a second installation cavity 21 is arranged inside the massage head 2; and a first elastic layer 3 wrapped around the massage rod 1 and the massage head 2 to connect the massage rod 1 and the massage head 2 to form the massager, where the massage rod 1 and the massage head 2 may move relative to each other due to the deformable characteristics of the first elastic layer 3 itself.

The massage rod 1 includes: a power device 41 fixedly provided within the first installation cavity 11 by adhesion, clamping, snap-fitting, or the like; a reciprocating telescopic assembly 5 further provided within the first installation cavity 11 and coupled to the massage rod 1, where one end of the reciprocating telescopic assembly 5 is coupled to the power device 41, and the other end of the reciprocating telescopic assembly 5 is provided with an output portion 523; and the reciprocating telescopic assembly 5 is configured to be driven by the power device 41 to perform reciprocating telescopic movement and rotation within the massage rod 1; and an oscillating connecting member 6, where a first connecting portion 61 and a second connecting portion 62 are provided at two ends of the oscillating connecting member 6, respectively; the first connecting portion 61 is fixedly connected to the output portion 523, and the second connecting portion 62 is rotatably assembled with the massage head 2.

A rotation axis of the output portion 523 relative to the massage rod 1 is k1, and k1 in this embodiment is the forward-backward direction. A rotation axis of the second connecting portion 62 relative to the massage head 2 is k2, and k1 and k2 are arranged non-collinearly. In this embodiment, an included angle α between k1 and k2 is 10°.

The power device 41 drives the massage head 2 to simultaneously perform reciprocating telescopic displacement along a lengthwise direction of the massage rod 1 and rotational displacement about the axis k1, enabling the massager to perform telescopic and oscillating massage.

Therefore, the operation of the power device 41 causes the output portion 523 to perform reciprocating telescopic movement along the forward-backward direction while rotating circumferentially, thereby enabling the oscillating connecting member 6 to perform reciprocating telescopic movement along the forward-backward direction to drive the massage head 2 to perform forward-backward telescopic movement. Due to the non-collinear arrangement of k1 and k2 and the rotation of the oscillating connecting member 6 with the output portion 523, the second connecting portion 62 rotates eccentrically relative to the first connecting portion 61 continuously. In addition, since the massage head 2 and the second connecting portion 62 are rotatably mated, the massage head 2 may perform continuous eccentric oscillation while performing reciprocating telescopic movement, so that the massage head 2 may generate forward-backward telescopic movement and large-amplitude circumferential oscillation, thereby delivering stronger impact massage to the massage part around the outer periphery of the massage head 2, resulting in better and more efficient massage for improved relaxation.

Specifically, the first elastic layer 3 includes a first encapsulation portion 31 wrapped around an outer periphery of the massage rod 1, a second encapsulation portion 32 wrapped around an outer periphery of the massage head 2, and a corrugated encapsulation portion 33 connecting the first encapsulation portion 31 and the second encapsulation portion 32 so that the massage rod 1 and the massage head 2 are each wrapped and sealed, and the junction between the massage rod 1 and the massage head 2 is also sealed.

The wrapping of the massage rod 1 by the first encapsulation portion 31 not only enhances the stability of the connection between the first elastic layer 3 and the massage rod 1, but also enhances user comfort by providing an elastic feel during massage. Similarly, the wrapping of the massage head 2 by the second encapsulation portion 32 not only enhances the stability of the connection between the first elastic layer 3 and the massage head 2, but also enhances user comfort by providing an elastic feel during massage. The corrugated encapsulation portion 33, through its corrugated shape, realizes deformation of the first encapsulation portion 31 and the second encapsulation portion 32 during the forward-backward telescopic movement and circumferential oscillation of the massage head 2 relative to the massage rod 1, ensuring smoother movement of the massage head 2 and preventing excessive stress buildup on the first elastic layer 3 that could lead to damage.

In addition, in this embodiment, a first vibration motor 42 is provided within the massage head 2 so that the operation of the first vibration motor 42 may cause the massage head 2 to vibrate, thereby further optimizing massage comfort.

Preferably, the first connecting portion 61 is rod-shaped and extends along the forward-backward direction, and the second connecting portion 62 is rod-shaped and extends along a k2 direction. The first connecting portion 61 and the second connecting portion 62 are integrally formed by bending.

Specifically, a front end of the massage head 2 is arranged with an oscillating insertion hole 22, and the diameter of the oscillating insertion hole 22 is slightly larger than the diameter of the second connecting portion 62, allowing the second connecting portion 62 to be inserted into the oscillating insertion hole 22 to achieve rotational mating between the massage head 2 and the second connecting portion 62.

Specifically, the reciprocating telescopic assembly 5 includes a reciprocating telescopic shell 50, a power rotating shaft 51, a telescopic rotating shaft 52, and a linkage member 53. An axial direction of the power rotating shaft 51 is along the forward-backward direction. A first end at the front of the power rotating shaft 51 is coupled to the power device 41 so that the power device 41 drives the power rotating shaft 51 to rotate. An axial direction of the telescopic rotating shaft 52 is also along the forward-backward direction. A first end at the front of the telescopic rotating shaft 52 slidably mates a second end at the rear of the power rotating shaft 51 in a circumferentially synchronous manner. An output portion 523 is provided at a second end at the rear of the telescopic rotating shaft 52. Specifically, the power rotating shaft 51 includes a mating insertion section 511 having a hexagonal prism shape, and the telescopic rotating shaft 52 is arranged with a mating insertion slot 521 having a hexagonal prism shape. The mating insertion section 511 is inserted into the mating insertion slot 521 so that the telescopic rotating shaft 52 may slide relative to the power rotating shaft 51 along the forward-backward direction while rotating circumferentially with the power rotating shaft 51. In addition, the telescopic rotating shaft 52 is arranged with a circular track 522 formed by an "8"-shaped groove concavely arranged on an outer wall of the telescopic rotating shaft 52. The linkage member 53 includes an installation column portion 531 rotatably provided relative to the massage rod 1 and a crescent-shaped sliding portion 532 slidably mating the circular track 522. A rotation axis of the installation column portion 531 relative to the massage rod 1 is k3. k1 and k3 are perpendicularly provided. The rotation of the power rotating shaft 51 enables the telescopic rotating shaft 52 to rotate circumferentially with the power rotating shaft 51 and simultaneously perform reciprocating sliding along the forward-backward direction through the cooperation between the crescent-shaped sliding portion 532 and the circular track 522. The installation column portion 531 is installed in the reciprocating telescopic shell 50 and pivotably provided about an axis of the installation column portion 531 as a rotating shaft, and the reciprocating telescopic shell 50 is fixedly provided relative to the massage rod 1.

The power device 41 drives the power rotating shaft 51 and the telescopic rotating shaft 52 to rotate synchronously, thereby driving the oscillating connecting member 6 to rotate. During the rotation process, the power rotating shaft 51 also performs reciprocating telescopic displacement relative to the telescopic rotating shaft 52 along the lengthwise direction of the massage rod 1 so that the massage head 2 simultaneously performs reciprocating telescopic motion and rotation about the axis k1.

Specifically, the power device 41 in this embodiment includes a drive motor 411 and a speed reduction device 412. The speed reduction device 412 connects an output shaft of the drive motor 411 to the power rotating shaft 51, and the drive motor 411 and the reciprocating telescopic assembly 5 are provided on front and rear sides of the speed reduction device 412, respectively. The drive motor 411 operates to drive the rotation of the power rotating shaft 51 through the speed reduction device 412. Thus, the structural arrangement is more orderly, and the overall structure is more compact. Moreover, the drive motor 411 outputs after speed reduction through the speed reduction device 412, resulting in a more reliable output speed.

In other embodiments, only the drive motor 411 may be used, and the output shaft of the drive motor 411 is be fixedly connected to the power rotating shaft 51 through a coupling.

Specifically, the reciprocating telescopic shell 50 further includes a main housing 54 and an end side cover 55. The main housing 54 is arranged with a telescopic channel 541 that penetrates the main housing 54 along the forward-backward direction, and both the power rotating shaft 51 and the telescopic rotating shaft 52 are configured within the telescopic channel 541. A rear end of the main housing 54 is arranged with a first clamping half-slot 542 having a semi-cylindrical shape, and a front side of the end side cover 55 is arranged with a second clamping half-slot 552. The end side cover 55 is configured at a rear side of the main housing 54 so that the first clamping half-slot 542 and the second clamping half-slot 552 cooperate to form a clamping slot that mates the installation column portion 531, thereby limiting the installation column portion 531 through the clamping slot to ensure stable rotation of the installation column portion 531.

The main housing 54 and the end side cover 55 adopt concave-convex mating and are fixedly installed through bolts. Similarly, the main housing 54 and the speed reduction device 412 adopt concave-convex mating and are fixedly installed through bolts.

In addition, in this embodiment, the first elastic layer 3 is provided with a connecting structure 34 at a front end of the massage rod 1, and the connecting structure 34 includes a plurality of connecting perforations 341 arranged circumferentially.

Therefore, wearing accessories such as ropes or straps may be assembled through the connecting perforations 341, allowing the massager to be worn on the user's body for more convenient use.

In addition, on a front side inside the first installation cavity 11, the massage rod 1 is provided with a circuit board 71, and a power supply battery 72, a control button 73, and charging contacts 74 that are electrically connected to the circuit board 71. The power supply battery 72 is provided on a side of the circuit board 71 and is fixed relative to the massage rod 1 by being clamped by the massage rod 1. The circuit board 71 is fixedly installed on the massage rod 1 through bolts or the like. The control button 73 and the charging contacts 74 are provided on a front side of the circuit board 71 and are fixedly connected to the circuit board 71 through pin soldering.

The drive motor 411 is connected to the circuit board 71 through a wire, and a first threading opening 23 is arranged at a front end of the massage head 2 so that the wire in the first installation cavity 11 may extend out of the massage rod 1 and enter the massage head 2 through the first threading opening 23 to be connected to the first vibration motor 42.

The power supply battery 72 supplies power to the entire circuit structure. The control button 73 is configured to control and switch the operation of the drive motor 411, the first vibration motor 42, and the like. The charging contact 74 charges the power supply battery 72.

Preferably, the charging contact 74 is a magnetic suction contact.

A first assembly opening 35 is arranged at a front end of the first elastic layer 3, and both the massage head 2 and the massage rod 1 are inserted into the first elastic layer 3 through the first assembly opening 35. In addition, a first cover 351 is provided at the first assembly opening 35 and fixedly connected to the front end of the massage rod 1 through snap-fitting to seal the first assembly opening 35. Further, a first silicone pressing portion 352 is provided on the first cover 351, and corresponds to the control button 73 so that the user operates the control button 73 by pressing the first silicone pressing portion 352.

The massage rod 1 is formed by assembling two left-and-right split parts so that the first installation cavity 11 may be opened by splitting the two parts of the massage rod 1. The massage head 2 is formed by assembling two front-and-rear split parts so that the second installation cavity 21 may be opened by splitting the two parts of the massage head 2.

### Embodiment 2:

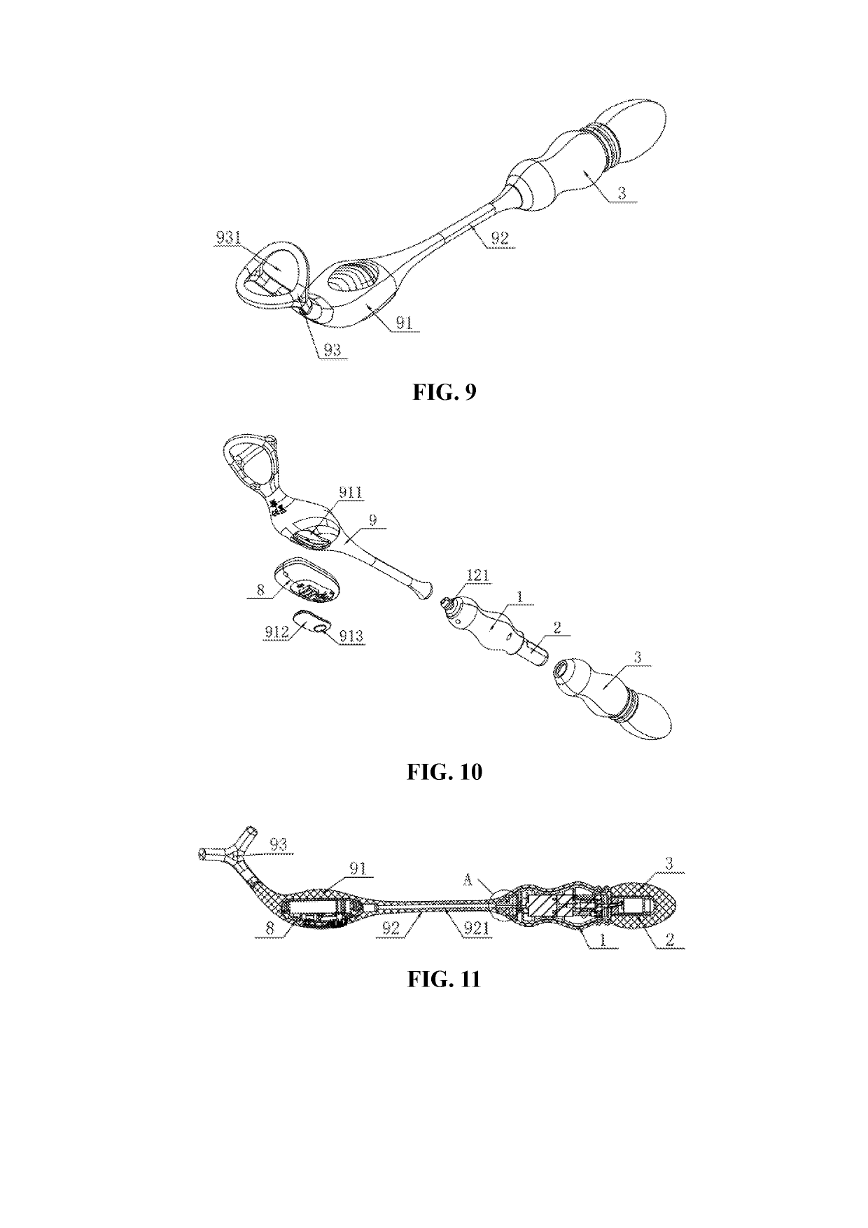

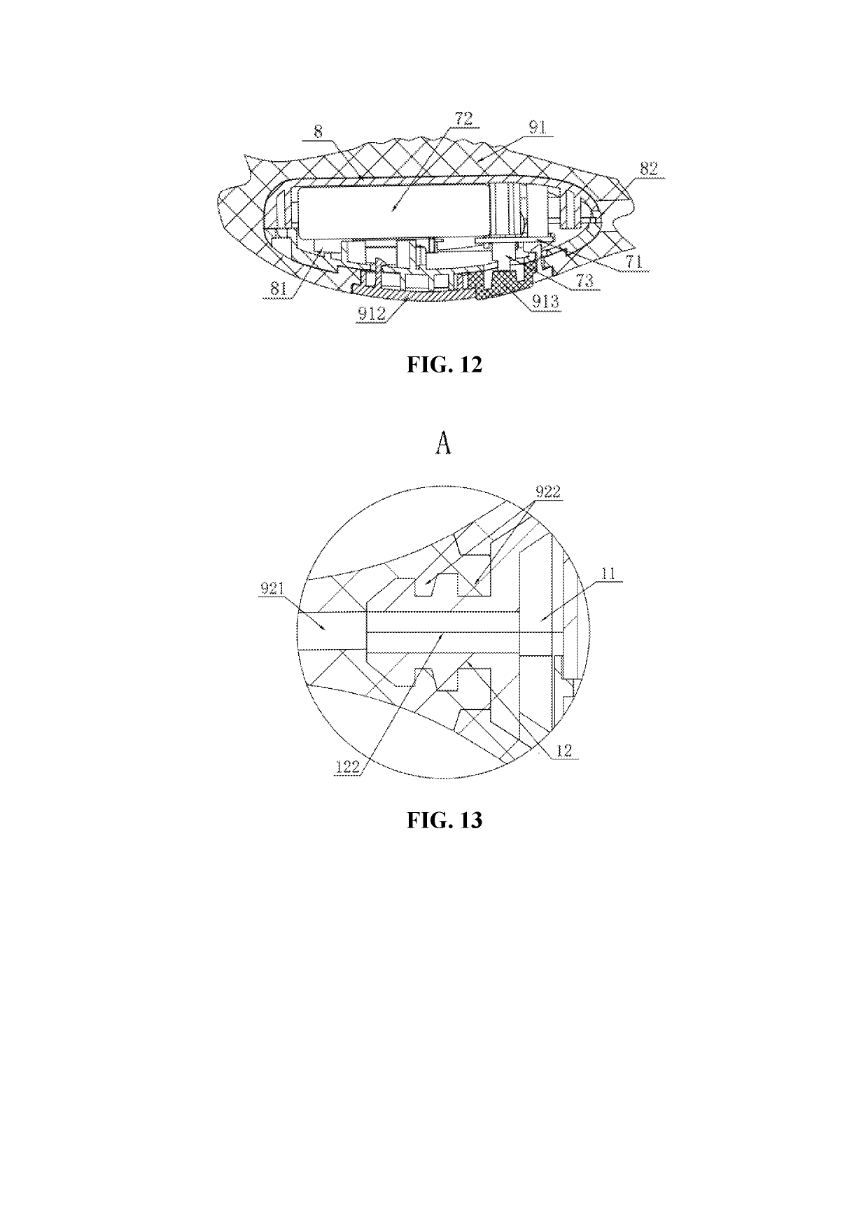

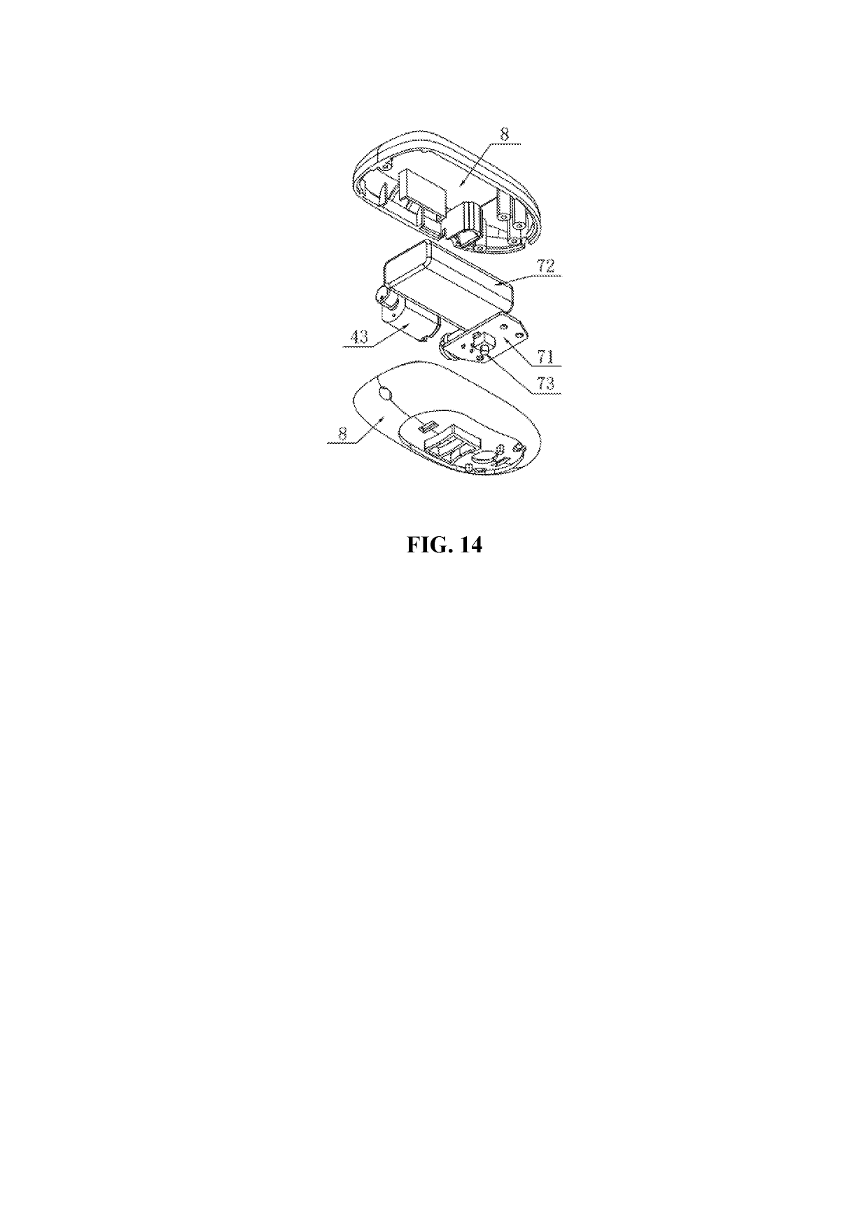

As shown in FIGS. 9-14, the present disclosure further provides a massager capable of telescopic and oscillating massage, the main structure of which is the same as that of embodiment 1, except that the circuit board 71, the power supply battery 72, the control button 73, and the charging contact 74 are not provided in the first installation cavity 11, and correspondingly, the first cover 351 is not provided.

In addition, the massager further includes a massage base 8 and a second elastic layer 9. The massage base 8 is located in front of the massage rod 1. The second elastic layer 9 includes a third encapsulation portion 91 wrapped around an outer periphery of the massage base 8, and a strip-shaped extension section 92 extending forward and backward. A lengthwise front end of the extension section 92 and the third encapsulation portion 91 are integrally formed and connected, and a lengthwise rear end of the extension section 92 sleeves the massage rod 1 through snap-fitting. In addition, a third installation cavity 81 is arranged inside the massage base 8, and a second vibration motor 43 is fixedly installed in the third installation cavity 81 by clamping.

Therefore, the massage base 8 may also vibrate through the operation of the second vibration motor 43, allowing the massage base 8 to contact the part to be massaged for vibration massage. In addition, due to the arrangement of the elastic extension section 92, the extension section 92 may be bent to enable the massage head 2 and the massage base 8 to simultaneously massage different parts, thereby improving comfort.

A front end of the massage rod 1 in this embodiment protrudes to form a connecting protrusion 12, and a plurality of annular snap slots 121 are arranged on an outer periphery of the connection protrusion 12 along the forward-backward direction. The extension section 92 is provided with a wire perforation 921 that penetrates the extension section 92 along the lengthwise direction, and a plurality of snap rings 922 are provided at a rear end of the wire perforation 921 so that the connecting protrusion 12 is inserted into the wire perforation 921, and the connection between the connecting protrusion 12 and the extension section 92 is achieved through the snap slots 121 and the snap rings 922. The connecting protrusion 12 is further arranged with a wire channel 122 that penetrates the connecting protrusion 12 to communicate the wire perforation 921 with the first installation cavity 11. In addition, a circuit board 71, and a power supply battery 72, a control button 73, and charging contacts 74 that are electrically connected to the circuit board 71, are provided within the third installation cavity 81. A rear end of the massage base 8 is arranged with a third threading opening 82 for the wire to pass through, so that the wire in the third installation cavity 81 extends out from the third threading opening 82 and enter the first installation cavity 11 through the wire perforation 921 and the wire channel 122 to electrically connect the drive motor 411 to the circuit board 71. Similarly, the wire may further extend forward from the first installation cavity 11 and enter the second installation cavity 21 through the first threading opening 23 to electrically connect the first vibration motor 42 to the circuit board 71.

In addition, the second elastic layer 9 is provided with a wearing portion 93 on a front side of the third encapsulation portion 91, and the wearing portion 93 is arranged with a wearing perforation 931 so that the massager may be worn on the body through the wearing perforation 931, and then the massage base 8 and the massage head 2 are brought into contact with the parts to be massaged for massage.

A second assembly opening 911 is arranged at a lower end of the third encapsulation portion 91, and the massage base 8 is inserted into the third encapsulation portion 91 through the second assembly opening 911. In addition, a second cover 912 is provided at the second assembly opening 911 and fixedly connected to the bottom of the massage base 8 through snap-fitting to seal the second assembly opening 911. Further, a second silicone pressing portion 913 is provided on the second cover 912, and corresponds to the control button 73 so that the user operates the control button 73 by pressing the second silicone pressing portion 913.

The massage base 8 is formed by assembling two upper-and-lower split parts so that the third installation cavity 81 may be opened by splitting the two parts of the massage base 8.

What is claimed is:

1. A massager capable of telescopic and oscillating massage, comprising:
a massage rod;
a massage head located at an outer end of the massage rod; and
a first elastic layer wrapped around the massage rod and the massage head to connect the massage rod and the massage head to form the massager; and
wherein the massage rod comprises:
a power device provided within the massage rod;
a reciprocating telescopic assembly provided within the massage rod and coupled to the massage rod, wherein one end of the reciprocating telescopic assembly is coupled to the power device, and the other end of the reciprocating telescopic assembly is provided with an output portion; and the reciprocating telescopic assembly is configured to be driven by the power device to perform reciprocating telescopic movement and rotation within the massage rod; and
an oscillating connecting member, wherein a first connecting portion and a second connecting portion are provided at two ends of the oscillating connecting member, respectively; the first connecting portion is fixedly connected to the output portion, and the second connecting portion is rotatably assembled with the massage head, wherein a rotation axis of the output portion relative to the massage rod is k1, a rotation axis of the second connecting portion relative to the massage head is k2, and k1 and k2 are arranged non-collinearly; and
the power device drives the massage head to simultaneously perform reciprocating telescopic displacement along a lengthwise direction of the massage rod and rotational displacement about the axis k1, enabling the massager to perform telescopic and oscillating massage.

2. The massager capable of telescopic and oscillating massage according to claim 1, wherein the first elastic layer comprises a first encapsulation portion wrapped around an outer periphery of the massage rod, a second encapsulation portion wrapped around an outer periphery of the massage head, and a corrugated encapsulation portion connecting the first encapsulation portion and the second encapsulation portion so that the massage rod and the massage head are each wrapped and sealed, and the junction between the massage rod and the massage head is also sealed.

3. The massager capable of telescopic and oscillating massage according to claim 1, wherein a first vibration motor configured to drive the massage head to vibrate is provided within the massage head.

4. The massager capable of telescopic and oscillating massage according to claim 1, wherein the massage head is arranged with an oscillating insertion hole; the second connecting portion is rod-shaped and extends along a k2 direction, and is rotatably inserted into the oscillating insertion hole.

5. The massager capable of telescopic and oscillating massage according to claim 4, wherein the first connecting portion is rod-shaped and extends along a k1 direction.

6. The massager capable of telescopic and oscillating massage according to claim 5, wherein the reciprocating telescopic assembly comprises a reciprocating telescopic shell, a power rotating shaft, a telescopic rotating shaft, and a linkage member; a first end of the power rotating shaft is coupled to the power device so as to be driven by the power device for rotation; a first end of the telescopic rotating shaft is coupled to a second end of the power rotating shaft so that the telescopic rotating shaft and the power rotating shaft are synchronously rotatable and slidably assembled; the output portion is provided at a second end of the telescopic rotating shaft; the telescopic rotating shaft is arranged with a circular track formed by an "8"-shaped groove concavely arranged on an outer wall of the telescopic rotating shaft; the linkage member comprises an installation column portion and a crescent-shaped sliding portion; the installation column portion is installed in the reciprocating telescopic shell and pivotably provided about an axis of the installation column portion as a rotating shaft, and the reciprocating telescopic shell is fixedly provided relative to the massage rod; and
the power device drives the power rotating shaft and the telescopic rotating shaft to rotate synchronously, thereby driving the oscillating connecting member to rotate; during the rotation process, the power rotating shaft also performs reciprocating telescopic displacement relative to the telescopic rotating shaft along the lengthwise direction of the massage rod so that the massage head simultaneously performs reciprocating telescopic motion and rotation about the axis k1.

7. The massager capable of telescopic and oscillating massage according to claim 6, wherein the power device comprises a drive motor and a speed reduction device.

8. The massager capable of telescopic and oscillating massage according to claim 6, wherein the power rotating shaft comprises a mating insertion section having a polygonal prism shape, the telescopic rotating shaft is arranged with a mating insertion slot having a polygonal prism shape, and the mating insertion section is inserted into the mating insertion slot.

9. The massager capable of telescopic and oscillating massage according to claim 8, wherein the reciprocating telescopic shell comprises a main housing and an end side cover; the main housing is arranged with a telescopic channel that penetrates the main housing along the k1 direction, and the telescopic rotating shaft is configured within the telescopic channel; one end of the main housing is arranged with a first clamping half-slot, and the end side cover is arranged with a second clamping half-slot; the end side cover is configured on the main housing so that the first clamping half-slot and the second clamping half-slot cooperate to form a clamping slot that mates the installation column portion.

10. The massager capable of telescopic and oscillating massage according to claim 1, wherein the first elastic layer is provided with a connecting structure at one end of the massage rod that faces away from the massage head, and the connecting structure comprises a plurality of connecting perforations arranged circumferentially.

11. The massager capable of telescopic and oscillating massage according to claim 10, wherein the end of the massage rod that faces away from the massage head is provided with a circuit board, and a power supply battery, a control button, and charging contacts that are electrically connected to the circuit board; the power supply battery is provided on a side of the circuit board, and the control button and the charging contacts are provided on one side of the circuit board that faces away from the power supply battery.

12. The massager capable of telescopic and oscillating massage according to claim 1, further comprising a massage base and a second elastic layer, wherein the second elastic layer comprises a third encapsulation portion wrapped around an outer periphery of the massage base, and a strip-shaped extension section; one lengthwise end of the extension section is connected to the third encapsulation portion and/or the massage base, and the other lengthwise end of the extension section is connected to the massage rod and/or the first elastic layer; and
a second vibration motor is provided on the massage base.

13. The massager capable of telescopic and oscillating massage according to claim 12, wherein the extension section is arranged with a wire perforation that penetrates the extension section along the lengthwise direction.

14. The massager capable of telescopic and oscillating massage according to claim 12, wherein the massage base is provided with a circuit board, and a power supply battery, a control button, and charging contacts that are electrically connected to the circuit board.

15. The massager capable of telescopic and oscillating massage according to claim 12, wherein the second elastic layer is provided with a wearing portion on one side of the third encapsulation portion that faces away from the extension section, and the wearing portion is arranged with a wearing perforation.
